(19) United States
(12) Patent Application Publication
(10) Pub. No.: US 2004/0080428 A1
(43) Pub. Date: Apr. 29, 2004

(54) RF audiovisual component remote control system

(75) Inventors: David John Rye, Kent, WA (US); Lesley Alan Leech, Kowloon (HK)

Correspondence Address: Marvin N. Gordon, Suite 2015, 630 Fifth Avenue, New York, NY, 10111, US

(73) Assignee: X10 Wireless Technology, Inc.

(21) Appl. No.: 10/279,614

(22) Filed: Oct. 25, 2002

(51) Int. Cl. G05B 19/02; G08C 19/00

(52) U.S. Cl. 340/825.69; 340/825.24

(57) ABSTRACT

A handheld remote control unit transmits binary coded rf address and control signals to an addressable transceiver where those signals are detected, decoded and processed to derive binary coded control signals that are coded in accordance with the brands or manufacturers of the audiovisual components that are to be controlled along with the function that is to be thus controlled for the addressed components.

### BACKGROUND OF THE INVENTION

I. Field of the Invention

The present invention relates to the remote control of audiovisual components.

II. Description of the Prior Art

The presence of a home entertainment system or center is rapidly becoming common in American homes as the quality of the several audio and video components used in such systems has increased while their prices have declined to make them more affordable to many households. A typical home entertainment center includes a television receiver, a DVD player, a cable box or converter, a control amplifier and tuner and a videocassette recorder (VCR). The operation of these components is commonly controlled by the use of one or more handheld remote control units, which, depending on the button pushed by the user, transmits binary-coded infra-red signals which are received and decoded by the associated audio or visual component to, for example, turn it “on” or “off”, change the channel, or open or close the disc holder in the case of a DVD player.

In many, if not most, of these home entertainment systems, the individual components are manufactured by different manufacturers. For example, a home entertainment center may include a TV receiver made by Sony, a DVD player made by Toshiba and a control amplifier made by Denon, each having a unique binary control code that controls its operation. To operate these components by remote control, the user must either use a different brand-specific remote control unit for each manufacturer's component, which is sold with that component, or purchase and program a so-called “universal” remote control that can be pre-programmed by the user to store the operating binary control codes associated with the several brands of the audiovisual components. These universal remote control units emit infrared signals that are coded in accordance with the stored codes specific to the several brands of audiovisual components that are to be controlled, and are thus able to replace the multiple brand-specific remote control units with a single unit.

Most currently available handheld remote control units are provided with a plurality of pushbutton switches that allow the user to enter control signals manually. Encoding circuitry in the unit, in response to the actuation of the particular control switch, produces binary coded electrical signals that uniquely identify the particular manually entered command. An infrared light emitter in the unit is driven to emit infrared light signals binary coded in correspondence to the encoded commands and to the brand of the audiovisual component to which the coded control signals are directed.

The audiovisual component whose operation is to be remotely controlled is typically provided with an infrared detector that receives the coded infrared control or command signal from the hand-held remote control, and converts the received coded command signal to an electrical signal to which the remotely controlled audiovisual component responds by executing the corresponding command, e.g., increase volume or change channel.

In recently issued U.S. Pat. No. 6,397,288, assigned to the assignee of the present application, I disclose a “virtual” remote control unit whose image is displayed on a PC monitor. The user by touching or clicking onto the appropriate areas of the image of the remote control unit selects a desired control function, e.g., TV “off” or “one”. An interface connected to an I/O port of the PC transmits a corresponding binary coded RF signal to a receiver at which the transmitted, coded signal is decoded and converted to a correspondingly coded infrared signal.

The control or command codes for the various brands of audiovisual components in the user's system are stored in a code library included in the receiver. Thus, for example, when the PC interface transmits an RF signal corresponding to “VCR Play” the receiver looks up in the receiver code library the code for the user's brand of VCR and then transmits an infrared coded signal for “Play” for that brand of VCR This system, although reliable and effective, does, however, require the use of a PC and accompanying additional software as well as the interface, which adds to the cost and complexity of the system.

U.S. Pat. No. 4,809,359 is of interest in its disclosure of a system for extending the effective operational range of an infrared remote control system. The disclosed system includes a first repeater that receives binary coded infrared commands from a remote control unit. The first repeater generates a corresponding RF signal representative of the received infrared signals. Those coded RF signals are received by a second repeater, which, in response, generates and transmits a corresponding coded infrared signal to the controlled component. U.S. Pat. No. 5,383,044 is of interest in its disclosure of an RF remote control system in which the infrared commands are modulated onto an RF carrier that is received at a receiver in which the commands are detected and the RF signal is converted to a corresponding coded infrared signal that is transmitted to the audiovisual component.

The remote control system described in U.S. Pat. No. 5,383,044 requires the use of a special RF remote and does not work with the user's existing infrared remote control. A further disadvantage of both of these prior patented remote control systems is that if the user owns more than one audiovisual component of the same brand, the user cannot use multiple receivers since the remote control would incorrectly and accidentally control the operation of both of these audiovisual components. For example, most television receivers respond to a “toggle function” for ON-OFF, that is, the same command code is transmitted from the remote control to turn it “on” or “off”. Thus, for example, if the user has two identical television receivers in different rooms and one of them is “on” and the other is “off”, the use of either of these patented remote controls to turn “on” a television that was “off” would improperly also turn “on” the other television that was “off”.

### SUMMARY OF THE INVENTION

It is an object of the present invention to provide a remote control system for use in controlling the operation of a multi-brand audiovisual component system that is cost-effective and reliable.

It is a more general object of the present invention to provide a remote control system of the type described that avoids the drawbacks and disadvantages of the prior art remote control systems.

It is another object of the present invention to provide a remote control system of the type described, which can address a receiver and is thus able to individually control multiple audiovisual components of the same brand and model located in different rooms of the user's home.

In accordance with the present invention, an “actual” remote control, rather than the “virtual” remote control disclosed in my U.S. Pat. No. 6,397,288, transmits coded RF binary signals to an addressable transreceiver where the signals are decoded to derive binary coded control signals and processed to code those signals in accordance with the manufacturer or brand of the audiovisual component that is to be remotely controlled by the coded control signals. The remote control system of this invention thus represents an improvement over that disclosed in U.S. Pat. No. 6,397,288 since it does not require the use of a PC and the software required to create the “virta” remote.

To this end, the addressable transceiver includes a memory for IR code library that stores the remote control codes for the commercial brands of audiovisual components, and a lookup table that stores the remote control codes for all the audiovisual components in the user's home. The library and lookup table are connected to a microprocessor in which the brand or product codes are combined with the received binary coded control signals. The thus processed and modified coded control signals are converted to corresponding coded infrared control signals which are transmitted to the selected audiovisual component.

### BRIEF DESCRIPTION OF THE DRAWINGS

To the accomplishment of the above and such further objects as may hereinafter appear, the present invention is directed to an RF remote control system substantially as defined in the appended claims and as described in the following detailed specification of a preferred embodiment thereof as considered with the accompanying drawings in which:

FIG. 1 is an elevation of a hand-held remote control unit which may be used in the remote control system of the invention;

FIG. 2 is a schematic block diagram of the remote control unit of FIG. 1; and

FIG. 3 is a schematic block diagram of a transceiver that can be used in the remote control system of the invention.

### DETAILED DESCRIPTION OF THE PREFERRED EMBODIMENT

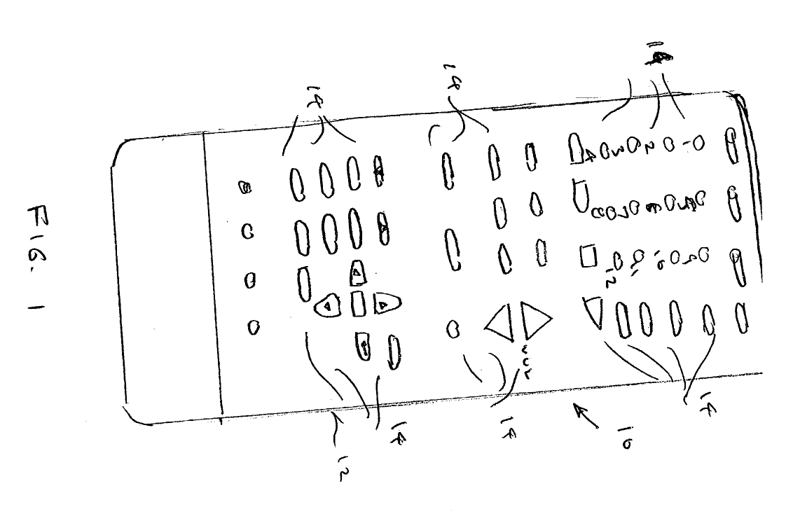

Referring to the drawings, there is shown in FIG. 1 an example of a hand-held remote control unit generally designated 10 that may be used in the remote control system of the present invention. As therein shown, unit 10 includes a housing or case 12 which contains the integrated circuits and other components of the unit, as is conventional. As is also conventional, unit 10 includes an array of pushbuttons 14, which, when pressed down by the user, actuate the internal circuitry contained in unit 10 to produce the appropriate binary coded commands or control signals that are transmitted from unit 10 to control selectively the audiovisual component, for example, to turn a DVD player “on” or raise the volume.

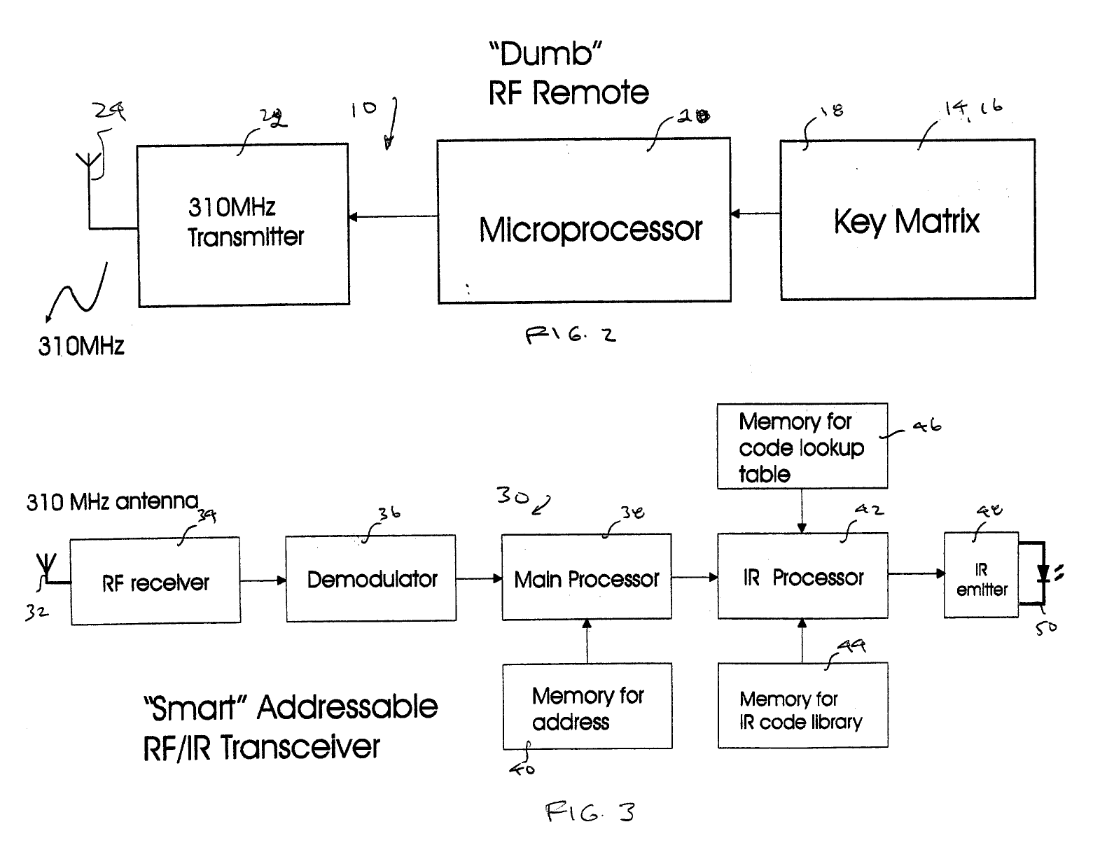

As shown in the schematic diagram of the remote control unit 10 depicted in FIG. 2, the unit 10 includes a key matrix 18, which, in a known manner, in response to the user operation of one of the pushbuttons 14 produces a memory address signal that is applied to a microprocessor 20 in which is stored a plurality of binary control codes corresponding to the various functions of the audiovisual components that are to be controlled by the operation of unit 10. The binary control codes stored in the microprocessor 20 are generic codes in that they are not specific for any particular brand or model of audiovisual product. The binary coded signal generated by the microprocessor 20, in response to the user operation of one of the pushbuttons 14, is applied to a modulator-transmitter 22 in which the microprocessor output binary coded control signal is modulated onto a radio-frequency carrier of e.g., 310 MHz. That radio-frequency binary coded signal is transmitted by an antenna 24 included in unit 10 to an addressable transceiver generally designated 30, illustrated schematically in FIG. 3.

As therein shown, transceiver 30 receives the binary coded address and function control rf signal from the remote control unit 10. In overview, those signals are converted in transceiver 30 to corresponding binary coded infrared (IR) signals, which are then transmitted over-the-air to the selected audiovisual component to control its operation. To this end, as shown in FIG. 3, transceiver 30 includes an rf antenna 32 whose output is connected to the input of an rf receiver 34. The output of receiver 34 is coupled to an input of a demodulator 36, the output of which is applied to an input of a main microprocessor 38. An address memory 40 is connected to another input of microprocessor 38. Memory 40 stores the addresses of the transceiver 30 (?) as well as the addresses of the various audiovisual components whose operation is to be remotely controlled in response to the binary coded rf signals received at transceiver 30 from the remote control unit 10. The transceiver's main processor 38 looks up its address in memory 40 and compares it to the address code received from unit 10 to check that the received command code is intended for this particular transceiver.

If an address match is detected in microprocessor 38 its output is applied to one input of an infrared (IR) processor 42, which receives at another input the contents of a universal IR code library memory 44. Memory 44 contains the remote control codes for all brands, e.g., Sony and Zenith, and models of commercially available audiovisual components. For example, if the audiovisual component is a television receiver identified on the user's remote control unit as TV 1 is a Sony and a second television receiver in the home identified as TV 2 is a Zenith, memory 44 would store the Sony remote control code for TV 1 and the Zenith remote control code for TV 2. (DAVE, WHERE AND HOW ARE TV1 AND TV 2 IDENTIFIED HERE?) IR microprocessor 42 also receives an input from a memory 46 for the code lookup table. The remote control codes stored in memory 46, which are derived from code library memory 44 through the microprocessor 42, may be periodically supplemented or otherwise modified by the user when a new audiovisual component is acquired or a currently owned component is discarded. IR processor 42 looks up the received control code, e.g., “VCR Play”, from the IR code library 44.

The output of the IR microprocessor 42 is applied to an IR emitter 48, which provides appropriately binary coded drive signals to an LED 50, which, in response, transmits correspondingly coded IR control signals to the selected or addressed audiovisual component, as desired. In an otherwise known manner, that component uniquely responds to the received IR coded address and control signal that contains its unique product remote control code.

In the operation of the transceiver 30 of FIG. 3. the binary coded rf control and address signals are received at antenna 32 and receiver 34 and then decoded or demodulated in demodulator 36 to remove the 310 MHz component from it. The binary output signal of demodulator 36 are applied to the main microprocessor 38 where the binary address portion of the signal is compared to the product address codes obtained from the address memory 40 to check that the function control code is intended for this particular addressable transceiver. In the event the received address signal matches one of the stored addresses, a signal is generated which is applied to the IR microprocessor 42.

IR processor 42 converts the input control signal so that it is compatible with the operating binary code for the selected audiovisual component whose IR remote control code is obtained from the look-up table 46. That is, if the control operation that is to be performed is to Play the VCR, the IR processor 42 looks up the “VCR-Play” code from the code library 44 for the user's particular brand of VCR. That control code for “VCR-Play” is selected in IR processor 42 and is then applied to IR emitter 48 to, in turn, cause LED 50 to transmit to the addressed or selected VCR, in the example given, the selected control signal in the form of an IR binary signal that is compatible with the user's brand and model of VCR.

A more specific example of this operation to control the channel select and volume control of an RCA TV receiver and the play function for a Toshiba VCR is as follows:

Send an RF code to address the transceiver 30

Send an RF code for a RCA TV, code 013.

Send an RF code for pushbutton # 1 (power).

Send an RF code for pushbutton # 2 (Channel up).

Send an RF code for pushbutton # 3 (Volume up).

Send an RF code for a Toshiba VCR, code 145.

Send an RF code for pushbutton # 1 (power).

Send an RF code for pushbutton #4 (play).

Send an RF code to unaddress the transceiver 30.

Transceiver 30 knows, for example, that code 013 identifies an RCA TV and that code 145 identifies a Toshiba VCR; all of these product codes are stored in its code library 44. Thus when transceiver 30 receives an RF binary coded signal from the remote unit 10 to turn on the user's model of the RCA TV, it recognizes and then sends the correct IR binary coded signal to turn that particular TV receiver “on”.

It will be appreciated from the foregoing description of a presently preferred embodiment that the remote control system of the present invention allows for the convenient and reliable remote control of the operation of a multiplicity of audiovisual components of the same or of different brands in the user's home. It will be further appreciated that whereas the remote control system of the invention has been described hereinabove with respect to that embodiment, modifications therein and thereto may be made without necessarily departing from the spirit and scope of the invention.

What is claimed is:

1. A remote control system for controlling the operation of a plurality of different audiovisual components, said system comprising a handheld remote control unit including means for producing and transmitting, in response to the user's operation of one or more pushbuttons on said unit, a series of binary coded, radio-frequency (RF) control and address signals, and a transceiver separate from said remote control unit, said transceiver comprising means for detecting and decoding said binary coded RF signals transmitted thereto by said remote control unit and means operatively connected to said detecting means for processing said decoded control signal, thereby to modify said decoded control signal to make said signal compatible with the brand of the audiovisual component whose operation is to be controlled by said binary coded control signal, and means operatively connected to said signal processing means for transmitted the thus modified control signal to the addressed audiovisual component.

2. The system of claim 1, in which said processing means includes a first memory storing a plurality of control codes for a corresponding plurality of brands of audiovisual components, the operation of which are to be controlled by said binary coded control signals.

3. The system of claim 2, in which said processing means further comprises a second memory for storing the universal remote control codes for commercially available audiovisual components and a first processor having an input operatively connected to said first memory.

4. The system of claim 3, further comprising a second processor operatively connected to said first processor and infrared (IR) transmitting means operatively connected to an output of said second processor.

5. The system of claim 4, further comprising a second memory including a code lookup table and a third memory including an IR code library, said second and third memories being operatively connected to said second processor.

6. The system of claim 1, in which said remote control unit transmits a binary coded signal modulated on a 310 MHz carrier.

7. The system of claim 1, in which said transceiver is addressable and includes means for detecting the receipt of its address signal from said remote control unit.

8. The system of claim 7, in which said address signal detecting means includes a microprocessor and a memory storing the transceiver address code operatively connected to said microprocessor.
